(19) United States
(12) Patent Application Publication
(10) Pub. No.: US 2009/0314463 A1
(43) Pub. Date: Dec. 24, 2009

(54) Radiant Panel

(76) Inventors: Raymond C. Frobosilo, Edison, NJ (US); Sam Borgia, Edison, NJ (US)

Correspondence Address: NOTARO & MICHALOS P.C., 100 DUTCH HILL ROAD, SUITE 110, ORANGEBURG, NY, 10962-2100, US

(21) Appl. No.: 12/432,408

(22) Filed: Apr. 29, 2009

Related U.S. Application Data
(60) Provisional application No. 61/073,453, filed on Jun. 18, 2008.

(51) Int. Cl. F24D 19/02; B32B 3/12; B32B 38/04; F24D 13/02; B21D 47/00

(52) U.S. Cl. 165/49; 428/116; 156/257; 392/432; 392/435; 29/897.3

(57) ABSTRACT

A radiant panel which can be used for heating or cooling and in floors, walls and ceilings, has a honeycomb layer of vertical metal webs or fins and rigid upper and lower cover boards rigidly adhered to upper and lower surfaces of the honeycomb layer. The upper cover board has router-cut channel there through, the channel having a width and being elongated in the shape of a selected pattern for at least one heat transfer tube that extends along the channel in the selected pattern. The tube is pressed into the honeycomb layer past the upper surface of the honeycomb layer for at least partly crushing the metal webs or fins of honeycomb layer in the areas of the channel for establishing a heat transfer engagement between the tube and the honeycomb layer. Dragon Board Brand construction board is preferred as the cover boards, the honeycomb layer as preferably aluminum and a heat reflecting layer is preferably adhered to the lower surface of the lower cover board.

### CROSS-REFERENCE TO RELATED APPLICATION

This patent application claims priority on the U.S. Provisional Application No. 61/073,453, filed on Jun. 18, 2008, which is incorporated herein by reference.

### FIELD AND BACKGROUND OF THE INVENTION

The present invention relates generally to the field of heating and in particular to a new and useful radiant heat floor panel and method of making the same.

U.S. Pat. No. 6,188,839 to Pennella discloses a radiant floor heating system with reflective layer and honeycomb panel disposed within a solidified cement or under board. A panel member having a laminated reflective material which serves as a thermal break is placed upon the hardened cement or under board.

### SUMMARY OF THE INVENTION

It is an object of the present invention to provide a radiant heat floor panel that has a honeycomb layer of vertical metal webs or fins and rigid upper and lower cover boards rigidly adhered to upper and lower surfaces of the honeycomb layer. The upper cover board has router-cut channel there through, the channel having a width and being elongated in the shape of a selected pattern for at least one heat transfer tube that extends along the channel in the selected pattern. The tube is pressed into the honeycomb layer past the upper surface of the honeycomb layer for at least partly crushing the metal webs or fins of honeycomb layer In the areas of the channel for establishing a heat transfer engagement between the tube and the honeycomb layer. Dragon Board Brand construction board is preferred as the cover boards, the honeycomb layer is preferably aluminum and a heat reflecting layer is preferably adhered to the lower surface of the lower cover board.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of a radiant heat floor panel according to the invention with a simulated partial pattern of heat transfer tubes visible in an upper surface of the panel;

FIG. 2 is an enlarged view of an edge and upper surface of the panel showing the end of a tube; and

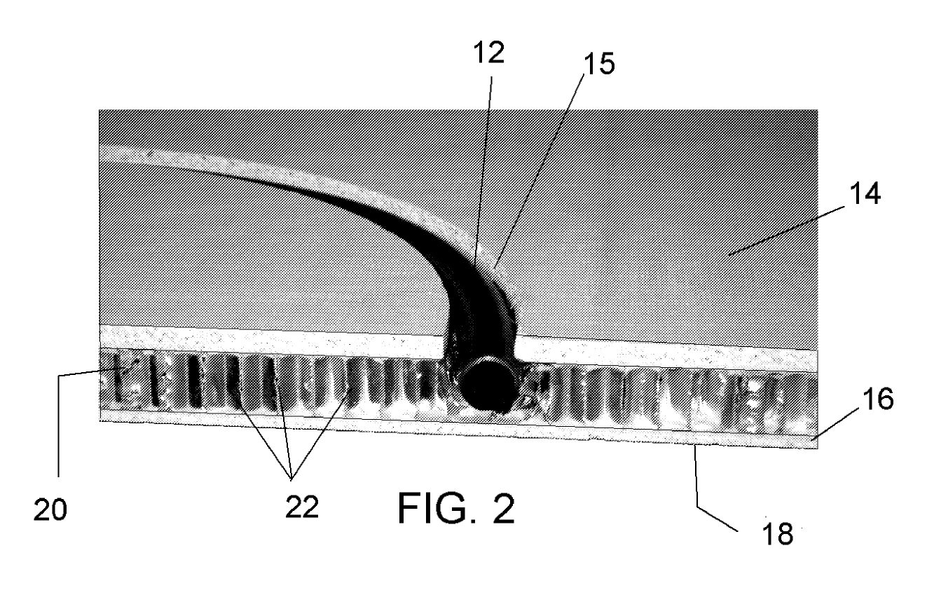

FIG. 3 is a partial enlarged edge and top view of the panel.

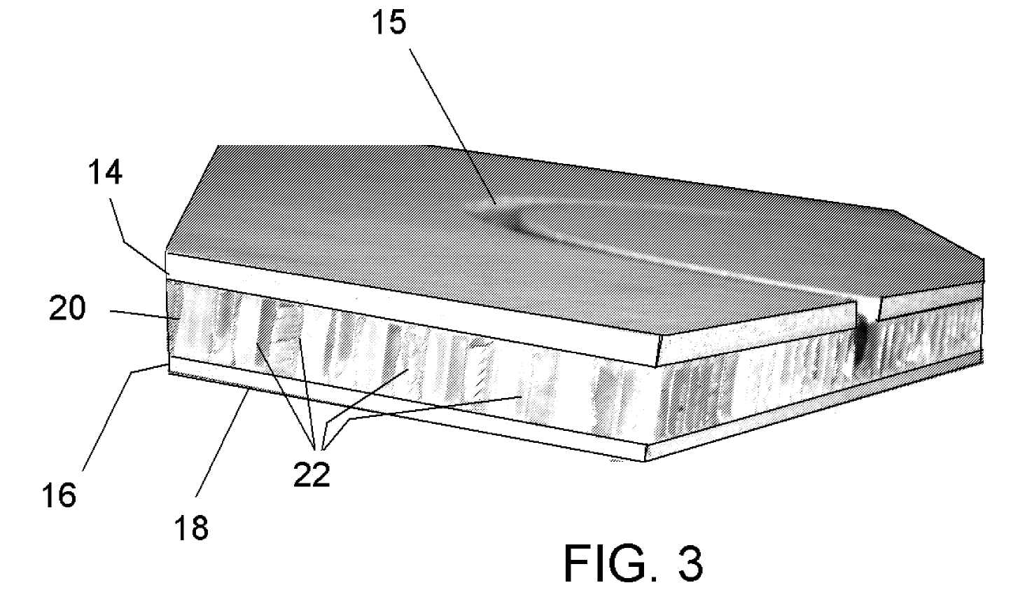

### DESCRIPTION OF THE PREFERRED EMBODIMENTS

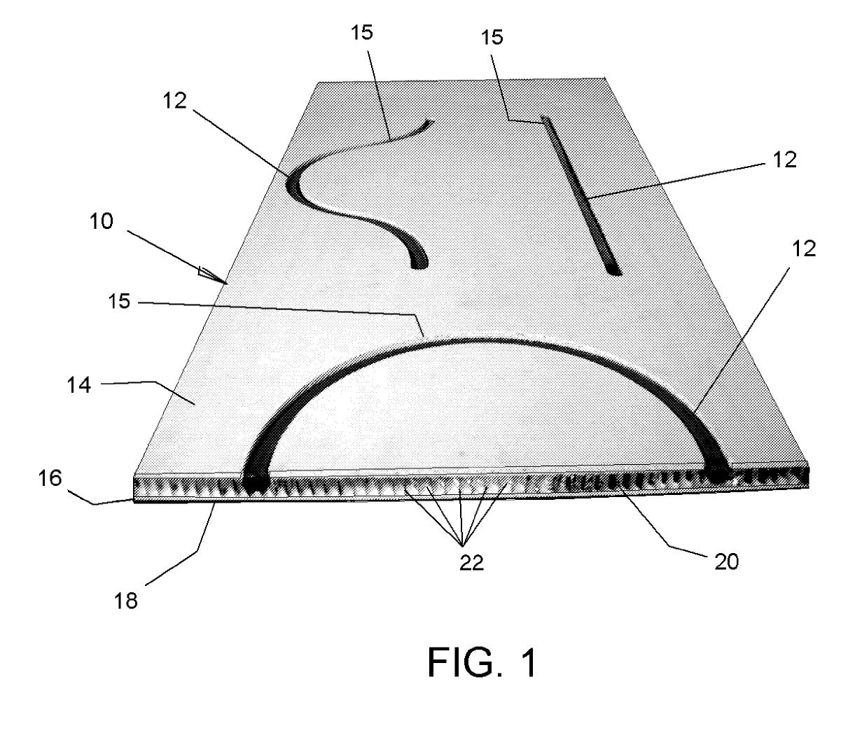

Referring now to the drawings, in which like reference numerals are used to refer to the same or similar elements, FIG. 1 shows radiant heat floor panel 10 of the invention which may be provided in the form of rectangular panels, e.g., 2×4 foot or 4×8 foot, or square of other shaped panels for use in the floor of a room to be preferably heated, but possibly even cooled by the panel.

The panel 10 comprises a honeycomb layer 20 made of a multiplicity of vertical metal, preferably aluminum, webs or fins 22 together forming a multiplicity of vertical cells, e.g., hexagonal or other polygonal or circular, oval, or sinusoidal or other shaped cells. The honeycomb layer 20 has an upper surface and a lower surface that are each rigidly adhered, e.g., by strong, waterproof epoxy resin or other suitable adhesive, to a rigid upper and lower cover boards 14 and 16, each having an upper surface and a lower surface.

The upper cover board has a channel 15 cut, preferably by router, there through, the channel having a selected width and being elongated in the shape of a selected pattern for at least one heat transfer tube 12 for the floor panel 10, the upper surface of the honeycomb layer being exposed by the channel.

At least one heat transfer tube 12 extends along the channel 15 in the selected pattern, the tube being pressed into the honeycomb layer, past the upper surface of the honeycomb layer for at least partly crushing the metal webs or fins of honeycomb layer in the areas of the channel for establishing a heat transfer engagement between the tube 12 and the honeycomb layer.

The upper and lower cover boards are each anywhere from 1/16 to ½ inch thick and are preferably of magnesium oxide plus magnesium chloride mixture that is commercially available under the trademark Dragon Board. For details on the composition of Dragon Board brand board, see U.S. Pat. No. 6,773,794 to Lindner assigned to Fairmount Distributors, Inc. of Jersey City, N.J. and incorporated here by reference.

The tubes or tubing 12 which sits in and is in heat transfer contact with the aluminum honeycomb layer 20, distributes heat evenly throughout the panel 10 for use as a floor. The top surface of the panel 10 may be covered with tile or first ¾″ plywood or other subfloor to protect the honeycomb against puncture, for example, from spike heels and the like. Honeycomb 20 is a stock item made in China for example, as are the Dragon Board boards 14 and 16.

The top layer of upper board 14 is routed into the pattern of the tubing 12 which is preferred commercially available PEX tubing. PEX tubing is cross-linked polyethylene. Through one of several processes, links between polyethylene molecules are formed to create bridges (thus the term “cross-linked). This resulting material is more durable under temperature extremes, chemical attack, and better resists creep deformation, making PEX an excellent material for hot water and other applications. Alternatively, copper or other heating or cooling medium tubing can be used.

After the routed path or pattern 15 is formed in the upper layer, the tubing 12, which is already pre-shaped into the corresponding shape, is pressed down into the honeycomb layer, thereby crushing the layer and producing a close thermal engagement between the outer surface of the tubing and the crushed aluminum. The pattern is likely to be a serpentine path that is spaced apart by an amount that is sufficient to enhance quick heat-up or at least effective heat-up of the entire panel through heat transfer through the honeycomb structure. Testing will be performed to optimize the spacing. Instead of PEX tubing the invention may utilize copper tubing.

It would be advantageous to minimize the amount of tubing for an area of panel to reduce back pressure and other limitations caused by too much tubing. It is important that the board be assembled using the routing out technique for establishing the path for the tubing to enhance connections at the end, when the ends of the tubes are connected to a manifold to supply the hot water.

For installation, a subfloor is placed over the joist and then the panels of the invention are placed on the subfloor and then the surface is treated as discussed earlier with either an additional layer of plywood or other required things to avoid the puncture problem. An alternate construction is to use a ¾″ for the lower Dragon Board layer; the honeycomb above, for example, ½″ and ⅜″ or ¼″ Dragon Board layer above and that becomes a self-supporting board that is put straight on to the joists. The PEX tubing that is going to be used in the construction models is ½″ ID and ⅝″ OD. So we are looking at ⅝″ channel that would accommodate a ⅝″ tubing that is pressed into the channel through the upper layer and into the honeycomb structure.

To this end the width of the channel 15 is selected to be about equal to, or slightly greater than or even slightly less than the diameter of the tube 12, so that the tube is actually forced past the channel and into the honeycomb layer 20 and locked In place In the now crushed webs or fins under the channel.

An important feature is that the routing go only through the upper surface and the webs or fins of the honeycomb layer stick upright In the channel so that the tubing is pushed down into the fins to crush the fins in different directions which produces the thermal engagement between the fins, the tube and the honeycomb layer.

The radiant heat floor panel 10 of the invention also includes a heat reflective layer 18, adhered to the lower surface of the lower cover board 16 for reflecting heat upwardly in the panel. Layer 18 may be made of aluminum or Mylar® polyester film coated with reflective metal or other know or to be discovered heat reflecting material.

To function as a radiant heat floor panel, the ends of the tube 12 are coupled to a suitable manifold of known design and hot water is passed through the circuit including the tube. Heat from the water is conductively passed to the crushed webs or fins and, due to the high thermal conductivity of the aluminum honeycomb layer 20, the heat quickly spreads across the entire panel and heat the upper and lower broads 14, 16. The reflective layer 18 reflects heat upwardly so that the upper surface of the panel 10 is preferentially heated.

Although most effective as a floor heating, the panel 10 can be used in walls or ceilings to provide radiant wall or ceiling heating and cool water of other fluid may be passed in tubes 12 to cool the panels and create a radiant cooling effect for floors, walls or ceilings.

While a specific embodiment of the invention has been shown and described in detail to illustrate the application of the principles of the invention, it will be understood that the invention may be embodied otherwise without departing from such principles.

What is claimed is:

1. A radiant panel (10) comprising:
a honeycomb layer (20) comprising a multiplicity of vertical metal fins (22) together forming a multiplicity of vertical cells, the honeycomb layer (20) having an upper surface and a lower surface;
a rigid upper cover board (14) having an upper surface and a lower surface and being rigidly adhered to the upper surface of the honeycomb layer (20);
a rigid lower cover board (16) having an upper surface and a lower surface and being rigidly adhered to the lower surface of the honeycomb layer (20);
the upper cover board (14) having a channel (15) cut there through, the channel (15) having a selected width and being elongated in the shape of a selected pattern for at least one heat transfer tube (12) for the floor panel (10), the upper surface of the honeycomb layer (20) being exposed by the channel (15); and
at least one heat transfer tube (12) extending along the channel (12) in the selected pattern, the tube (12) being pressed into the honeycomb layer (20) past the upper surface of the honeycomb (20) layer for at least partly crushing the metal webs (22) of honeycomb layer (20) in the areas of the channel (15) for establishing a heat transfer engagement between the tube (12) and the honeycomb layer (20).

2. A radiant panel (10) according to claim 1, wherein each cover board (14, 16) comprises a mixture of inorganic magnesium compounds, pulverized wood fibers, water and glass or synthetic fiber cloth with fine plastic fibers.

3. A radiant panel (10) according to claim 1, wherein each cover board (14, 16) comprises a mixture of inorganic magnesium compounds and are each about 1/16 to ½, inch thick, the honeycomb layer (20) being about ½ to ¾ inch thick and the metal webs or fins (22) being made of aluminum.

4. A radiant panel (10) according to claim 1, wherein each cover board (14, 16) comprises a mixture of magnesium oxide and magnesium chloride

5. A radiant panel (10) according to claim 1, wherein said lower cover board (16) is about ¾″ thick, said honeycomb layer (20) is about ½″ thick, and said upper cover board (14) is one of about ⅜″ and about ¼″ thick.

6. A radiant panel (10) according to claim 1, wherein said panels are rectangular, said panels being one of 2 feet by 4 feet and 4 feet by 8 feet.

7. A radiant panel (10) according to claim 1, wherein said panels are square.

8. A radiant panel (10) according to claim 1, wherein said selected pattern of said channel (15) is a spaced apart serpentine pattern.

9. A radiant heat floor panel (10) according to claim 1, wherein said at least one heat transfer tube (12) is comprised of cross-linked polyethylene.

10. A radiant floor panel (10) according to claim 9, wherein said at least one heat transfer tube (12) is about ½″ ID and about ⅝″ OD.

11. A radiant panel (10) according to claim 1, wherein said at least one heat transfer tube (12) is comprised of copper.

12. A radiant panel (10) according to claim 1, said at least one heat transfer tube (12) having ends which are coupled to a manifold creating a circuit.

13. A radiant panel (10) according to claim 12, wherein hot water is passed through said circuit.

14. A radiant panel (10) according to claim 1, including a heat reflective layer (18) adhered to the lower surface of the lower board (14) for reflecting heat upwardly in the panel (10).

15. A radiant panel (10) according to claim 14, wherein said heat reflective layer (18) is comprised of aluminum.

16. A radiant panel (10) according to claim 14, wherein said heat reflective layer (18) is comprised of polyester film coated with one of a reflective metal and an other know heat reflecting material.

17. A method of manufacturing a radiant panel (10) comprising:
providing a honeycomb layer (20) comprising a multiplicity of vertical metal fins (22) together forming a multiplicity of vertical cells, the honeycomb layer (20) having an upper surface and a lower surface;
adhering a rigid upper cover board (14) having an upper surface and a lower surface, to the upper surface of the honeycomb layer (20);
adhering a rigid lower cover board (16) having an upper surface and a lower surface, to the lower surface of the honeycomb layer (20);
using a router to cut a channel (15) into the upper cover board (14), the channel (15) having a selected width and being elongated in the shape of a selected pattern for at least one heat transfer tube (12) for the floor panel, the upper surface of the honeycomb layer (20) being exposed by the channel (15); and
pressing at least one heat transfer tube (12) into the channel (15) in the selected pattern, the tube (12) being pressed into the honeycomb layer (20) past the upper surface of the honeycomb layer (20) for at least partly crushing the metal webs (22) of honeycomb layer (20) in the areas of the channel (15) for establishing a heat transfer engagement between the tube (12) and the honeycomb layer (20).

18. A method of manufacturing a radiant panel (10) according to claim 17 comprising:
using a router to cut a channel through only the upper surface of said upper cover board (14) so that the fins (22) of the honeycomb layer (20) stick upright in the channel; and
pressing at least one heat transfer tube (12) into the channel (15) so that the fins are crushed down in different directions which produces a heat transfer engagement between the fins, the tube and the honeycomb layer.

19. A method of installing a radiant panel (10) of the type claimed in claim 1, comprising:
placing a sub-flooring material over a joist;
placing at least one radiant panel of the type claimed in claim 1 over the sub-flooring material; and
covering a top surface of said at least one radiant panel with an additional layer of sub-flooring.

20. A method of installing a radiant panel (10) as claimed in claim 19, comprising covering a top surface of said at least one radiant panel with tile.

21. A method of installing a radiant panel (10) as claimed in claim 1, comprising covering a top surface of said at least one radiant panel with ¾ plywood.
